(19) United States
(12) Patent Application Publication
(10) Pub. No.: US 2005/0136998 A1
(43) Pub. Date: Jun. 23, 2005

(54) Spring biased hinge and methods therefor

(76) Inventors: Michael F. Spence, Libertyville, IL (US); Roger W. Harmon, Crystal Lake, IL (US)

Correspondence Address: MOTOROLA INC, 600 NORTH US HIGHWAY 45, ROOM AS437, LIBERTYVILLE, IL, 60048-5343, US

(21) Appl. No.: 10/745,278

(22) Filed: Dec. 23, 2003

(51) Int. Cl. H04M 1/00

(52) U.S. Cl. 455/575.3

(57) ABSTRACT

A closeable device having first housing (110) coupled to a second housing (120) such that the first housing is planarly rotatable relative to the second housing. The closeable device, includes a compression spring (134), extending radially from an axis of rotation (128). The axis of rotation is perpendicular to a face (104) of the device which extends in a first plane. A cam (122) coupled to the second housing rotates about the axis of rotation. A follower (102) coupled between the cam and the compression spring causes the first housing portion to planarly rotate relative to the second housing portion. The compression spring compresses along a compression axis perpendicular to the axis of rotation and within the first plane.

### FIELD OF THE DISCLOSURE

The present invention relates generally to electronics devices and, more particularly to portable wireless handsets having multiple housing portions that are hinged together and rotate between open and closes positions.

### BACKGROUND

Wireless cellular communications devices having hinged flip portions are known generally. For example, a compression spring biased cam that engages a cam follower to pivot a housing member, such as a cover or flip portion, about an axis of rotation that is the same the axis of the compression spring is known.

U.S. Pat. No. 5,640,690 entitled “Hinged Assembly Having Cam Follower” discloses, for example, a compression spring biased cam that engages a cam follower to pivotal a body member cover or flip portion.

Wireless or portable communication devices continue to add features while maintaining or even reducing the device size to promote portability. The existing hinges of folding devices take up space within the housing, which reduce the amount of already limited space that is available for the incorporation of other desirable features. Control over the motion of the relative housing portions is also limited. Additionally, the incorporation of an open assistance feature is limited, takes up valuable space within the device or is not possible with the existing hinge assemblies.

Some hinges force a spring urged follower into a detent cam, positioning the two elements at various angles relative to one another, based on the position of the detent. U.S. Pat. No. 3,644,023 entitled “Hinged Spring-Loaded Spectacle Hinge” discloses, for example, a spring biased cam means that forces a follower into a detent to hold the side arms in a respective service position. These hinges, however, do not provide motion of one element relative to the other element.

The various aspects, features and advantages of the present invention will become more fully apparent to those having ordinary skill in the art upon careful consideration of the following Detailed Description of the Invention with the accompanying drawings described below.

### BRIEF DESCRIPTION OF THE DRAWINGS

FIG. 1 is an exemplary electronics device having a hinge.

FIG. 2 is an exemplary wireless communications handset schematic block diagram.

FIG. 3 is an exemplary cross section of the electronics device having a hinged portion.

FIG. 4 is an exemplary electronic device in a first rotation position.

FIG. 5 is an exemplary cross sectional view of a hinge follower.

FIG. 6 is an exemplary cross sectional view of a cam and follower hinge.

FIG. 7 is an exemplary free body diagram illustrating exemplary forces of the cam follower assembly.

FIG. 8 is an exemplary sectional view of a cam and follower hinge.

FIG. 9 is an exemplary electronics device having a hinge.

### DETAILED DESCRIPTION

While the present disclosure is achievable by various forms of embodiment, there is shown in the drawings and described hereinafter present exemplary embodiments with the understanding that the present disclosure is to be considered an exemplification and is not intended to limit the claims below to the specific embodiments contained herein.

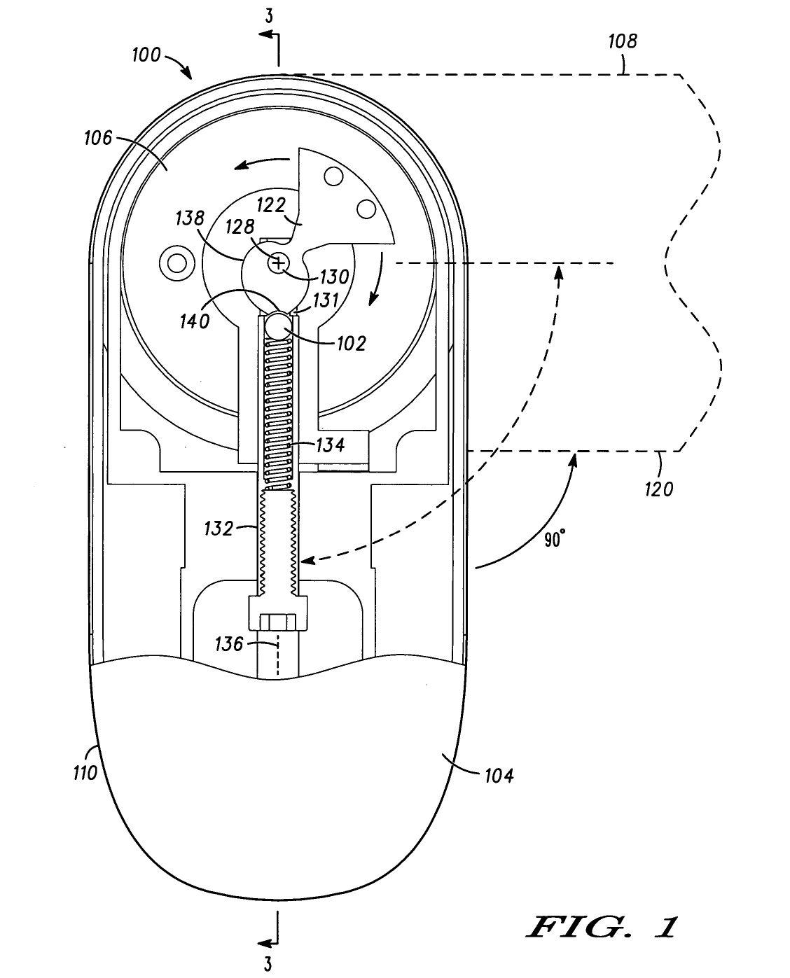

FIG. 1 illustrates an exemplary closeable electronic device 100 in an open position. In the exemplary embodiment, the electronics device 100 is a radiotelephone. The radiotelephone 100 described herein is a representation of the type of wireless communication device that may benefit from the present invention. However, it is to be understood that the present invention may be applied to any type of hand-held or portable electronic device including, but not limited to, the following devices: radiotelephones, cordless phones, paging devices, personal digital assistants, portable computers, pen-based or keyboard-based handheld devices, remote control units, an audio player (such as an MP3 player), including handheld storage containers, for example, a pocket-sized cigarette container, and the like. Accordingly, any reference herein to the radiotelephone 100 should also be considered to apply equally to other hand-held or portable electronic devices.

The device 100 is shown having a first housing 110, for example a radiotelephone handset housing, pivotally coupled to a second housing 120 or cover, for example a radiotelephone phone flip. A spring biased hinge, couples the first housing 110 to the second housing 120, and affects the motion of the first housing 110 relative to the second housing 120. However, the hinges and spring biasing mechanisms of the present invention may be used more generally in any application where it is desirable to provide a spring-biased hinge, in a collapsible device as will become more fully apparent from the discussion below.

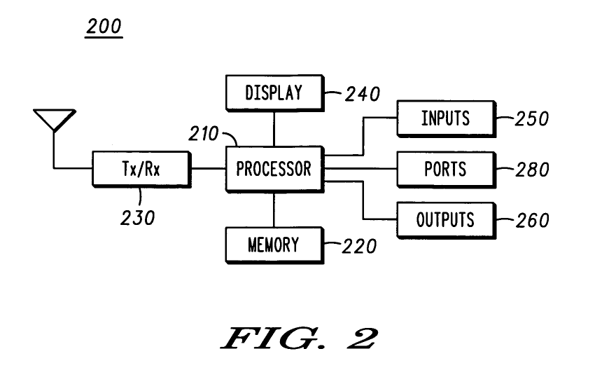

FIG. 2 is an exemplary wireless communications handset schematic block diagram 200 comprising generally a processor 210 coupled to memory 220, for example RAM, ROM, EPROM, etc. The exemplary wireless handset also includes a radio transceiver 230, a display 240, optionally a touch screen display, optionally a second display, inputs 250, for example a keypad, a microphone and video inputs, outputs 260, for example a sound and tactile or haptic outputs, and other ports 280, for example power, audio, etc., all of which are coupled to the processor.

The various elements of the exemplary radiotelephone 100, for example the processor, memory, inputs, outputs are disposed generally in a housing. The display is often mounted on the housing whether it is a part of a one piece assembly, or a multiple piece assembly where the housing elements move relative to one another. The housings may also include a keypad or keypads. The location and arrangement of these exemplary wireless handset elements is only an exemplary application and is immaterial to the structure of the hinges and spring biasing mechanisms, which are discussed more fully below.

In reference again to FIG. 1, an exemplary radiotelephone 100 in an open position is provided having a first housing 110 and a second housing 120. The first housing 110 has an elongated shape with at least a first face 104. The second housing 120 has a similar elongated shape with a second face (not shown) In a closed position the second housing 120 substantially covers the first housing 110 wherein the first face 104 and the second face are substantially planarly adjacent. The second housing 120 rotates relative to the first housing 110 about a rotation axis 128 which is substantially perpendicular to at least the first face 104 of the first housing 110. The first housing 110 includes a hollow portion 132 that carries a follower 102 and a yielding member 134. The follower 102 and the yielding member 134 reciprocate within the hollow portion 132, the exemplary combination of which may be considered to be a biasing member or assembly. In other embodiments, the biasing member does not require the hollow portion, for example, in applications where other structure provide support for the spring or in embodiments where the spring is sufficiently stiff not to require a carrier or support. The follower may be integral with the spring or it may be a discrete element. In the exemplary embodiment the spring is of the compression type, though in other embodiments it may be a torsion spring or a leaf-type spring or some other spring member.

The second housing 120 includes a retaining ring 106 carrying the cam 122, the cam 122 having a contoured surface portion 138 adapted to engage the follower 102. The first housing 110 rotates about rotation axis 128 relative to the second housing 120 such that the first face 104 and the second face maintain the same plane while rotating. A hinge pin 130 extends from the first housing 110 to the second housing 120 along the rotation axis 128.

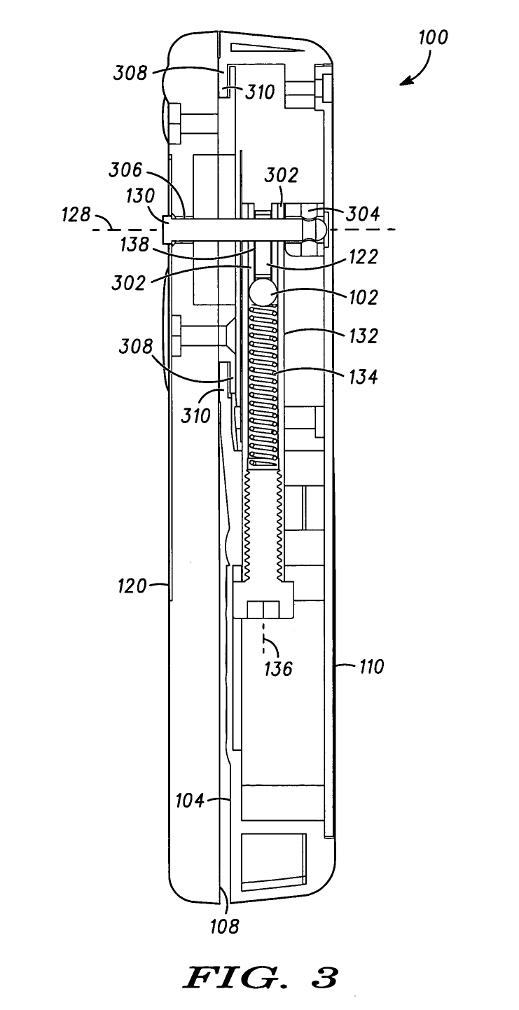

In reference to FIG. 3, a cross section of the exemplary embodiment shown in FIG. 1 illustrates the first housing 110 and the second housing 120 in a closed position. The first housing 110 includes the hollow portion 132 including a void or notch 300 at a cam end 131 thereof. The notch 300 forms a fork 302 in the cam end 131 of the hollow portion 132 that straddles the cam 122 such that the cam 122 is partially enclosed between the two tines of the fork 302 of the hollow portion 132. The hinge pin 130 extends though the fork 302 and the cam 122 allowing the cam 122 to rotate between the tines of the fork 302. The follower 102 engages both the cam 122, between the tines of the fork 302, and the yielding element 134, within the hollow portion 132. The hinge pin 130 is coupled to the first housing at a first housing bushing 304 and is coupled to the second housing 120 at a second housing bushing 306. While the exemplary embodiment include two tines, other embodiments may include only a single tine.

The cam 122 is carried on the retaining ring 106 extending from the ring inward to the center of the retaining ring 106. The retaining ring 106 rotatably couples the first housing 110 to the second housing 120 preventing the second housing 120 from separating from the first housing 110. A flange 308 on the retaining ring 106 supports the second housing 120 within the first housing 110 by mating with a support edge 310 of the first housing 110. The retaining ring 106 is rigidly fixed to the cam 122 such that when the cam 122 rotates, the retaining ring 106 rotates as does the second housing 120, which is attached thereto.

The hinge pin 130 is a shaft that extends through a portion of the first and second housings (110, 120) and substantially perpendicular to at least the first face 104 of the first housing 110. The hinge pin 130 also extends through the cam 122 and the hollow portion 132. The retainer ring 106 is coupled between the cam 122 and the second housing 120. In other embodiments, the cam 122 may be coupled to the second housing 120 and retained by the first housing portion 110 by alternative pivotal coupling mechanisms, for example by a ball bearing race or a Teflon surface. The hinge pin 130 aligns with the axis of rotation 128 of the cam 122 and hence the second housing 120 relative to the first housing 110.

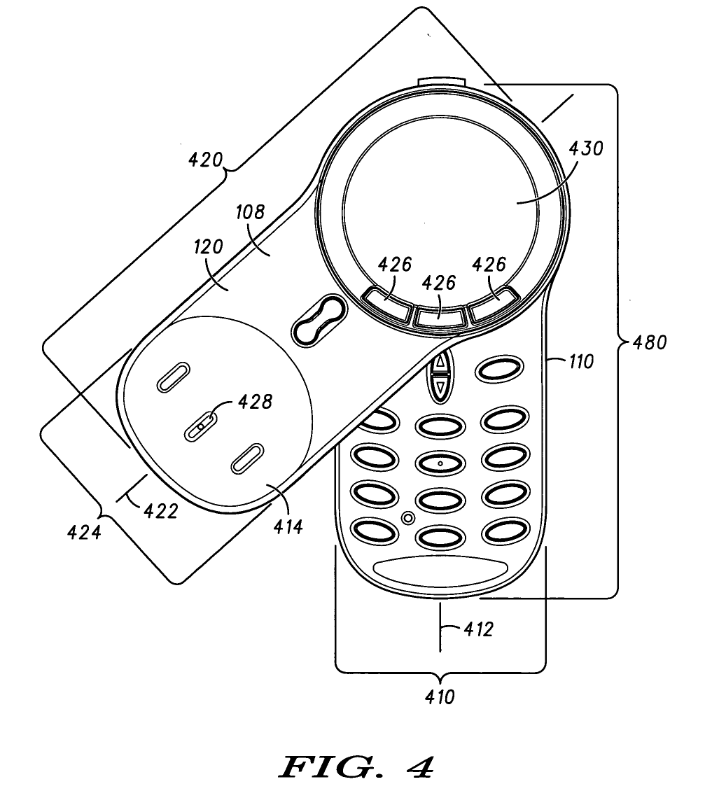

In reference to FIG. 4 the first housing 110, shown in the exemplary embodiment of the device 100 is in a first open position 400. The first housing 110 having an elongated shape and at least a first face 402 which is substantially flat. The first face 402 carries a user interface 404 in this embodiment that is accessible to the user when the radiotelephone 100 is in the first open position 400. The user interface 404 may be a display, a keypad, a touch screen or any combination thereof, or the like. The first housing 110 has long dimension 408 and a short dimension 410, the long dimension 408 having a longitudinal axis 412 running the length of the long dimension 408.

Also illustrated in FIG. 4, is the second housing 120 having an elongated shape, similar to that of the first housing 110, and at least a second face 108. The second face 108 may or may not have a user interface. If the second face 108 does carry a user interface, the user interface may be a display, a keypad, a touch screen, a camera or any combination thereof. In the exemplary embodiment shown in FIG. 4, the second face 108 has a display 430 and buttons 426. The second housing 120 may also have third face 414. A user interface, or user interfaces, may be carried on the third face 414, which in the exemplary embodiment, is on an opposing side to the second face 108 of the second housing 120. The second housing 120 has long dimension 420 and a short dimension 424, the long dimension 420 having a longitudinal axis 422 running the length of the long dimension 420. In the illustrated embodiment, the second housing 120 principally functions as a cover, which as noted above can also include some functional electronic components, such as selection buttons 426, a speaker 428, a display 430 or indicator lights. However, in the illustrated embodiment, a majority of the functional electronic components are included as part of the first housing 110, which is also referred to as the body or lower housing. As a cover, the second housing 120 substantially covers the first housing 110 when in a closed position protecting the components on the first face 104.

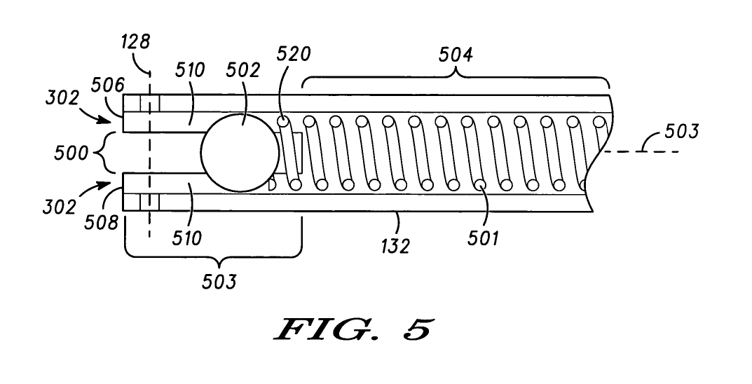

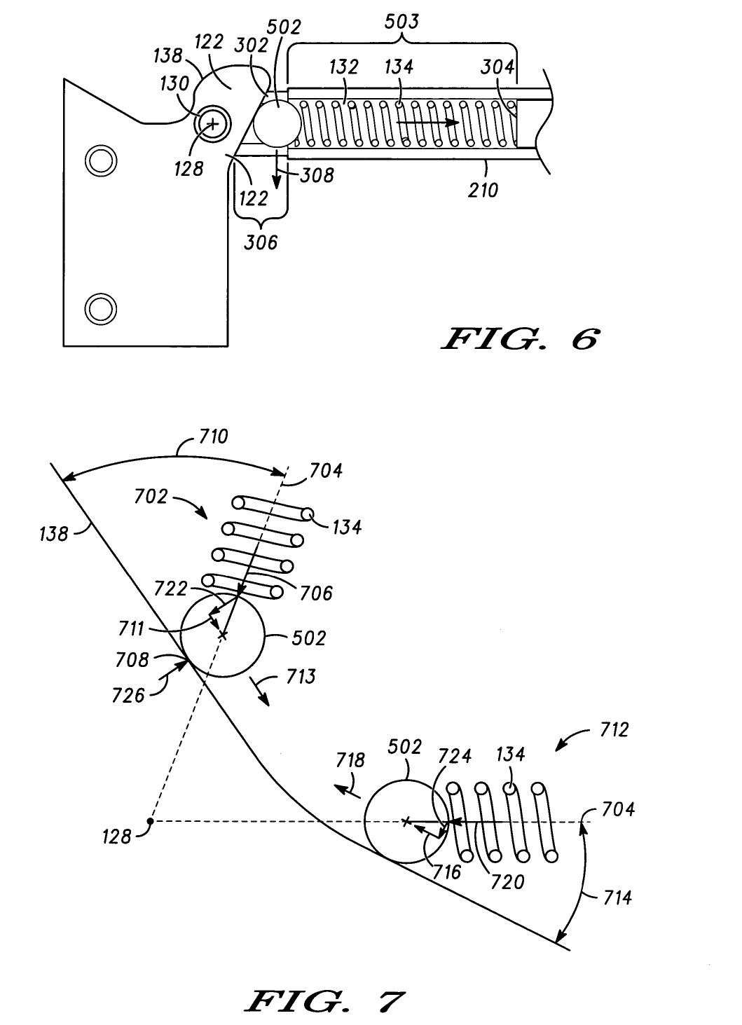

Referring to FIG. 5, a cross section of the hollow portion 132 is shown coupled to the cam 122. The hollow portion 132 retains the yielding member 134 which is a compression spring 501 in the exemplary embodiment, and the follower 102 is a spheroid 502 in the exemplary embodiment, such as a ball bearing or the like. The hollow portion 132 aligns the follower 502 with the cam 122. The hollow portion 132 has two portions, a hollow portion cam end 503 and a hollow portion yielding member end 504. The fork 302 is located at the hollow portion cam end 503 and comprises a first tine 506 and a second tine 508. The fork 302 allows the follower 102 to align with the cam 122 and at the same time, allows the cam 122 to rotate between the first tine 506 and the second tine 508 of the fork 302 of the hollow portion 132. The tines (506, 508) of the fork 302 guide the follower 102 such that the follower 102 does not escape from the hollow portion 132 laterally during reciprocation in conjunction with the rotation of the cam 122. The hollow portion 132 guides the follower 102 to reciprocate in a plane which is perpendicular to the axis of rotation 128 and within the same plane as the rotation of the second housing 120 relative to the first housing 110.

The fork 302 is formed by the notch 500 and the two tines of the hollow portion cam end 503 of the hollow portion 132. The tines (506, 508) of the fork 302 are extensions of the hollow portion 138 such that an inner surface 510 of the hollow portion yielding member end 504 continues to the tines. The continuous shape of the inner surface 510 allows the follower 102 and the yielding element 134 to seamlessly reciprocate in both portions of the hollow portion 132.

The hollow portion 132 may be a chamber carried in the second housing 120 or may be a chamber integrally formed into the first housing 110. Whether the hollow portion 132 is carried as an independent component in the first housing 110 or an integral part thereof, the inner surface 510 has a dimension that accommodates the follower 102, sphere 502 in the exemplary embodiment, and the compression spring 501, allowing the sphere 502 and the compression spring 501 to reciprocate along the long dimension of the hollow portion 132 as the follower 102 interacts with the cam 122.

The first tine 506 has a first void and the second tine 508 has a second void for receiving the hinge pin 130. The hinge pin 130 extends through the first void, the cam 122 and through the second void. The cam 122, the hollow portion 132 and the follower 102 make up the cam-follower assembly coupled together by the hinge pin 130. The hollow portion 132 rotates about the hinge pin 130 that extends through the first and second voids.

The compression spring 501 yields to the follower 102 in a reciprocating motion in response to the rotation of the cam 122 as the first housing 110 pivots about the rotation axis 128. The compression spring 501 is compressible along a compression axis 503 of the compression spring 134 along a center axis 136 of the hollow portion 132. The compression axis 503 is substantially perpendicular to the first face 104 of the first housing 110. The compression spring 501 is disposed such that it applies a force to the follower 102 wherein the follower 102 remains coupled to the contoured surface 138 at all points along the contoured surface 138. The compression spring 501 has a magnitude of compression in response to changes in the contoured surface portion 138 as the second housing 120 pivots about the axis of rotation 128. In the embodiment shown in FIG. 5, the compression spring 501, is compressably disposed in the hollow portion 132. The compression spring 501 is compressible along the compression axis 503 of the compression spring 134 disposed along a center axis 136 of the hollow portion 132. In the exemplary embodiment shown in FIG. 5., the compression spring 501 is oriented such that it applies a force to the follower 102 wherein the follower 102 remains in contact with the contoured surface portion 138 at all points along the contoured surface portion 138.

The follower 502 has a curved surface, e.g., a spheroid, ellipsoid, or other friction reducing shape, in the exemplary embodiment illustrated FIG. 5. The follower is guided within the hollow portion 132 by at least a portion of the fork 302 at the hollow portion cam end 503. The follower 132 may also traverse along the hollow portion beyond the fork 302 as the cam 122 rotates. More particularly, as the distance from the rotation axis 128 to the contoured surface portion 138 in contact with the follower increase, the follower moves farther away from the rotation axis into the hollow portion 132. Consequently, the compression spring 501 is compressed further exerting a greater rotational force on the first and second housings 110, 120. The follower 502 either rolls along or slides along the contoured surface portion 138 of the cam 122 or a combination thereof. The follower 502 seats in the follower end 520 of the compression spring 503. As the follower 502 moves, rolling or sliding or a combination thereof, along the contoured surface portion 138 it may rotate within the follower end 520 of the compression spring 501.

The fork 302 captures and guides the follower 102 such that it aligns with the cam 122 and the compression spring 501 and at the same time, allows the cam 122 to rotate between the first tine 506 and the second tine 508 of the fork 302 of the hollow portion 132.

The cam 122 is positioned inside of the first housing 110 by the retaining ring 106 and is coupled to the hollow portion by the hinge pin 130 and the follower 502. The cam 122 is centered about the rotation axis 128. In the exemplary embodiment, the rotation axis 128 of the cam is centered about the long axis 412 of the first housing 110 and the long axis 422 of the second housing 120. The cam 122, and hence the second housing 120, rotate about the rotation axis 128 relative to the first housing 110. In the exemplary embodiment, the contour surface portion 138 of the cam 122 is designed to achieve the motion of the second housing 120 relative to the first housing 110. The change in diameter of the cam, at positions along the contour surface portion 138 cause the cam 122 to rotate about the rotation axis 128 as a result of the force exerted on the cam by the follower 502 and the compression spring 501 as described below. In other embodiment, the the proportions may be changed and/or the biasing member located to provide a different leveraging action on the cam.

Depending on the relative location of the follower 102 on the contour surface portion 138 of the cam 122, the second housing 120 is either stationary or rotating relative to the housing portion 120. The location and motion of the second housing 120 is a consequence, of the follower 102 interaction with the contoured surface portion 138 as the cam 122 rotates about the axis of rotation 128. The cam follower assembly is one source of force acting on the second housing 120. The rotation of the second housing 120 is a result of the force of the follower 336 on the cam 122 as the follower 102 moves across the contoured surface portion 138. The motion of the follower 102 across the contoured surface portion 138 is at least a function of the yielding element force and the slope of the contoured surface portion 138 relative to the second housing 120. The force of the yielding element, or compression spring 501, and the angle of the slope of the contoured surface portion 138 relative to the direction of the yielding element force, determines the magnitude of the force acting on the second housing 120 by the yielding element via the follower 502.

As the yielding element force urges the follower 102 toward the contoured surface portion 138, the contact between the follower 102 and the contoured surface portion 138 creates two component forces. These two components are perpendicular to one another, and are reactive to the yielding element force. When the angle or slope of the contoured surface portion 138 is not perpendicular to the yielding element force, a first component of the reactive force is created and acts parallel to the contoured surface portion 138 thereby urging the follower 102 to traverse the contoured surface portion 138. Consequently the cam 122 and the retaining ring 106 in turn applies a force against the second housing 120. A second component force reacts in a direction which is 180 degrees, or substantially opposite to the yielding element force.

The opposing end of the compression spring 134, is held fixed at a position along the hollow portion 132 by an end of the hollow portion 132 or a fixturing element within the hollow portion 132 such as a wall or screw or bracket or combination thereof, within the hollow portion 132. The outside dimensions of the hollow portion 132 does not have to resemble a tube like structure, as long as the yielding member 134 in the hollow portion 132 is free to travel in a direction along the compression axis 302 and in response to the urging force of the cam follower action assembly. In the exemplary embodiment, the inside diameter of the hollow portion 132 is large enough to accept and allow the compression spring 501 to move freely therein. This cam follower assembly is completely internal to the first housing 110 leaving the outer surfaces of the first and second housing portions free of hinge components creating an esthetically pleasing look.

The force diagram, shown in FIG. 7 illustrates the yielding element force and the resulting or reactive force 726 on the follower 502 as a result of both the yielding element force and the slope of the contoured surface portion 138. FIG. 4 shows the follower 502 in a first position 702. The yielding element force 706 acts along the compression axis 704 urging the follower 502 toward the contoured surface portion 138. The follower 502 contacts the contoured surface portion 138 at a first contact point 708 where the slope has a first angle 710 relative to the compression axis 704. The application of the yielding element force 706 to the follower 502, which is in contact with the first angle 710, results in a first parallel force 711 parallel to the contour surface portion 138, at the point of contact for the first position 708. The first parallel force 711 causes the follower to traverse across the contoured surface portion in a first direction 713 of the first parallel force 711.

Also shown in FIG. 7 is the follower 502 in a second position 712. At the second position 712, the angle of the slope is a second angle 714 relative to the compression spring axis 704. In this configuration, the second parallel force 716 acts on the follower 502, and because of the second angle 714 the follower 502 traverses in a second direction 718, substantially opposite to the first direction 713. The magnitude of the compression spring force 706 in the first position 702, may or may not be the same as the compression spring force 720 in the second position 712. The direction of the traveler is dependent upon the angle of the contoured surface portion slope. A force substantially perpendicular to the to the contoured surface, a first perpendicular force 722 at the first position 702 and a second perpendicular force 724 at the second position 712, urges the follower to maintain contact with the contoured surface portion 138.

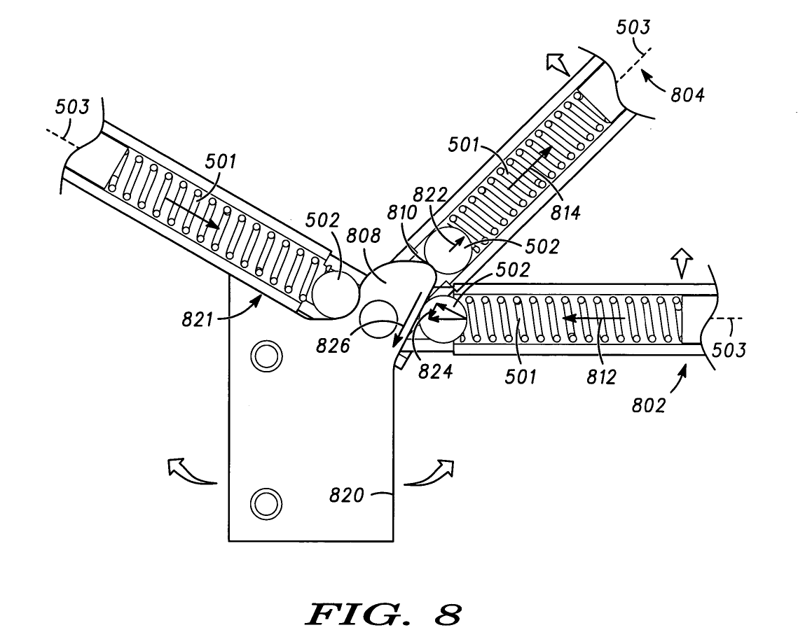

As illustrated in FIG. 8, one embodiment of the present invention comprises the hollow portion 132 and the second housing 120, which pivots or rotates about the axis of rotation 128. FIG. 8 illustrates the interaction between the hollow portion 132, the follower 502, the cam surface 138 and the compression spring 501 as the second housing 120 rotates relative to the first housing 110 about the axis of rotation 128. The cam 122 and consequently second housing 120 attached thereto, pivot from a first position 802 to a second position 804, for example about the axis of rotation 128. As the second housing 120 pivots about the axis of rotation 128, the follower 502 in the illustrated embodiment, rolls or slides along a cam surface 138 of the cam 122 while being urged against the cam surface 138 by the compression spring 134. The angle of the cam surface 138 relative to the hollow portion 132 and the compression spring axis 503 changes as the contour of the cam surface 138 changes.

When the angle of the cam surface 138, at the point of contact with the follower 501, is perpendicular to the compression spring axis 302, such as at position 804, a reactive force 822 of the cam surface 138 on the follower 502 is substantially opposite and parallel to the force of the compression spring 501. As the angle of the cam surface 138 changes relative to the compression spring axis 503, such as at position 802, a lateral component reactive force 824 results. This lateral component reactive force 824 is parallel to the contour surface portion 138 at the point of intersection of the cam 122 surface and the follower 502. The lateral component reactive force 824 urges the follower 502 to move along the contour surface portion 138 in the direction illustrated by the first arrow 826 of the lateral component reactive force 824. As the follower 502 is urged in the direction of the lateral component reactive force 824, the follower 502 exerts a follower force 828 on the hollow portion, causing second housing 120 to rotate about the axis of rotation 128.

As the second housing rotates about the axis of rotation 128, the compression spring 501 compresses or decompresses in response to the shape of the contoured surface portion 138 maintaining the force on the follower 502. As the cam 122 rotates from the first position 802 on the contoured surface 138 to second position 804 on the contoured surface portion 138, the distance between the contoured surface portion 138 and the axis of rotation 128 of rotation changes, resulting from a varying contour of the contoured surface portion 138. This change in distance, or contour, causes the compression spring 134 to compress and decompress a varying amount as the follower 592 moves along the cam surface 138 and moves longitudinally within the hollow portion 132 in the direction of the compression spring axis 503. The follower force 828, exerted by the follower 502 on the hollow portion 132, causes the second housing 120 to rotate about the axis 128. The follower force 828 is applied against the side of the hollow portion 132 a distance away from the first axis 128 resulting in a torque that rotationally biases the arms of the cover 110. The magnitude of the torque is a function of the lateral component reactive force 824, which is a function of the angle or slope of the cam surface 142 relative to the arm and the force due to the compression spring 134.

The contoured surface portion 138 dictates the amount of compression and correspondingly the force the compression spring 134 applies against the cam follower assembly at the various positions along the contoured surface portion 138. The variation in force creates the torque profile. The contoured surface portion 138 can be shaped to achieve a desired torque profile having specific desired values at particular points along the contoured surface portion 138 and hence at different points of rotation of the second housing 120 relative to the first housing 110. This allows the designer to vary the torque profile, via the contoured surface portion 138 that ultimately affects the force applied to the second housing 120 at the different points of rotation. For example in one exemplary embodiment, the contoured surface portion 138 is shaped similar to a triangle 508 having a rounded tip portion 810. The rounded tip portion 810 allows the follower to traverse more easily over the cam surface 142. At the first position 802 in FIG. 8, the compression spring begins to exert a force 812. This can be a nominal force where the compression spring 134 is in a resting or at a near equilibrium position, or a force less than the maximum force achieved when the compression spring 134 is compressed all the way. However, the spring force 812 at the first position 802 cannot be the maximum spring force, in this embodiment as this would prevent the compression spring 134 from compressing further, and consequently preventing the cam 122 from rotating. In the preferred embodiment the compression spring 501 exerts a different force 814, at the point along the contoured surface portion 138 that forms the rounded tip 810 of the contoured surface portion 138. In-between the first position 802 and the second position 804, the compression spring 501 compresses further and correspondingly generates an increasing amount of force until it reaches the second position 804. It should be noted that other forces are associated with other rotational positions other than the ones specifically exemplified in FIG. 8. One skilled in the art will appreciate the correlation between the position of the arm and the resulting force due to the relative amount of spring compression with in the cam follower assembly.

The resulting torque produced by the force applied to the second housing 120 by the cam follower assembly is such that just prior to the arm reaching the second position 804 (i.e. before the follower 502 meets the rounded tip 810 of the contoured surface portion 138 the force of the compression spring 501 urges the ball bearing 502 to travel along the contoured surface portion 138 in a direction away from the rounded tip 810 of the contoured surface portion 138, and back toward the first position 802. As a consequence, this force biases the cam 122 in a direction that will rotate the second housing 120 toward the first position 802. In one embodiment, a first physical stop 821 prevents the cam 122 from rotating beyond a third position 806. Similarly a second physical stop 820, holds the cam 122 in the fourth position (not Shown). Coincidentally, the contour of the contoured surface portion 138 at the first position 802 is such that the second housing 120 is biased towards the closed position with enough force to maintain contact or closure of the second housing 120 relative to the housing portion 120 until a force is exerted by the user. This can also be independent of or in conjunction with the first physical stop if present.

Similarly, once the second housing 120 is rotated past the second position 804 (i.e. the follower 502 moves beyond the rounded tip 810 of the contoured surface portion 138 at the second position 804, the force 813 produced by the spring 501 urges the follower 502 to move away from the second position 804 toward the third position 806 which coincides with the open position of the first housing 110 relative to the second housing 120. This is but one example of topology of the cam surface 138 that creates one possible desired motion of the cover 110. Other exemplary contoured surfaces will be discussed below.

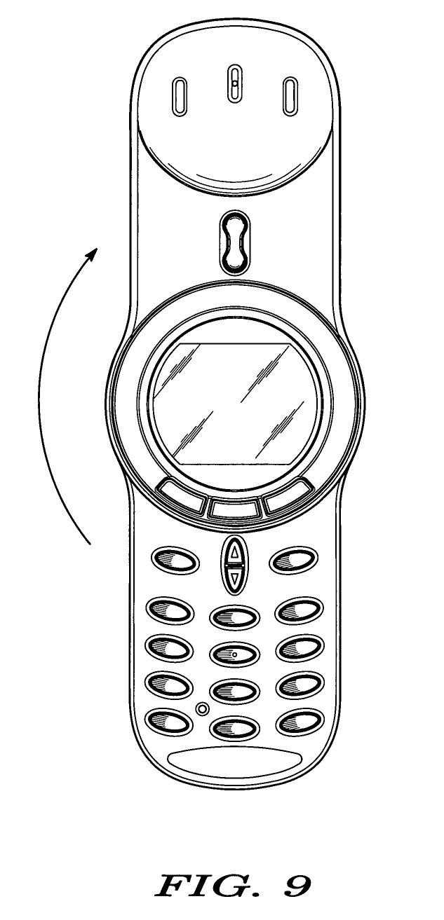

For example, referring back to FIG. 1, the topology of the contoured surface portion 138 urges the second housing 120 to automatically open to the 90 degree angle position 900. A 90 degree detent 140 in the cam 122 holds the second housing 120 at the 90 degree angle until the second housing 120 is either rotated back to the closed position or to a full open position FIG. 9 where the second housing is 180 degrees relative to the first housing 110. When moving from a position where the follower is positioned in a detent on the cam 122, the second housing 120 will move automatically once the follower 502 is manually moved along the cam 122 to a point that overcomes the cam 122 as discussed above in reference to FIG. 8.

The cam follower assembly assists the user in opening and positioning the device for use. The contoured surface portion of the cam 122 causes the first housing 110 to rotate relative to the second housing 120 and position as the user desires. A detent in the cam 122 may keep the device in the closed position. When the user exerts a force great enough to displace the follower 102, 502 from the detent in the contoured surface portion 138 of the cam 122, the cam follower interaction automatically causes the second housing to rotate to the next desired position defined by a stop on the cam 122 or a detent in the contoured surface portion 138. The next detent at the 90 degree position (FIG. 1) may be used for a camera position or to rotate the display to a landscape orientation. Rotating the device to a 180 degree open position FIG. 9, may be a radiotelephone or gaming mode. The are examples and as one skilled in the art realize there are multiple functions which may be associated with the relative positions of the housing portions.

While the present inventions and what is considered presently to be the best modes thereof have been described in a manner that establishes possession thereof by the inventors and that enables those of ordinary skill in the art to make and use the inventions, it will be understood and appreciated that there are many equivalents to the exemplary embodiments disclosed herein and that myriad modifications and variations may be made thereto without departing from the scope and spirit of the inventions, which are to be limited not by the exemplary embodiments but by the appended claims.

1. An apparatus having a pivot member useable in a handheld electronic device comprising:
a first panel having a first face extending in a first plane;
a second panel having a second face, the second panel rotateably coupled to the first panel such that the second panel rotates about a rotation axis which is substantially perpendicular to the first plane;
a pivot member coupled to the first panel and the second panel, the pivot member extending along the rotation axis;
a cam coupled to and rotational about the pivot member, the cam coupled to either the first panel or the second panel;
a guide member carried on the first panel or the second panel, which ever the cam is not coupled, the guide member extending radially from the rotation axis, enclosing a portion of the cam and coupled to the pivot member;
a yielding member disposed in the guide member; and
a follower disposed in the guide member in-between the yielding member and the cam.

2. The apparatus according to claim 1, wherein the rotation axis is located along and perpendicular to a longitudinal axis of the first panel.

3. The apparatus according to claim 2, wherein the rotation axis is located along and perpendicular to a longitudinal axis of the second panel.

4. The apparatus according to claim 3, wherein the guide member is hollow portion.

5. The apparatus according to claim 4, wherein the hollow portion is a tubular hollow portion.

6. The apparatus according to claim 5, wherein the tubular hollow portion has a notch at a cam end of the tubular hollow portion, the notch forming a fork having at least a first tine.

7. The apparatus according to claim 6, wherein the fork straddles the cam, and wherein the pivot member extends though the at least a first tine and the cam.

8. The apparatus according to claim 7, wherein the follower has a sphereical surface.

9. The apparatus according to claim 8, wherein the yielding element is a compression-type spring, torsion-type spring or a leaf-type spring.

10. The apparatus according to claim 1, wherein the follower has a curved surface.

11. The apparatus according to claim 1, wherein the yielding element is a compression spring.

12. The apparatus according to claim 1, wherein the first panel rotates relative to the second panel about the rotation axis from
a first position wherein the second panel substantially covers the first panel and are planarly adjacent, to
a second position wherein the second panel is angularly displaced from the first panel, such that the first face and the second face extend in the first plane.

13. The apparatus according to claim 1, wherein the first panel rotates relative to the second panel about the rotation axis from
a first position wherein the second panel substantially covers the first panel and are planarly adjacent, to
a second position wherein the second panel is angularly displaced at a right angle from the first panel, such that the first face and the second face extend in the first plane.

14. The apparatus according to claim 1, a detent in the cam is positioned within the cam surface to hold the first panel in the second position.

15. The apparatus of according to claim 1, at least one edge of the cam that engages the guide member to limit rotation of the cam.

16. A pivot assembly in a handheld device, comprising:
a housing having a substantially flat surface extending in a first plane;
a cover coupled to the housing, the cover covering at least a portion of the substantially flat surface wherein the cover is rotatable within the first plane about a rotation axis that is perpendicular to the first plane;
a cam coupled to one of the housing or the cover, the cam rotateable within the first plane;
an elongated hollow portion carried within the cover or the housing, which ever the cam is not, the elongated hollow portion extending radially within the first plane from the rotation axis, enclosing a portion of the cam;
a follower movable within the elongated hollow portion; and
a yielding element disposed within the elongated hollow portion and engageable by the follower such that the yielding element urges the follower to engage and force the cam to rotate such that the cover rotates relative to the housing in the first plane.

17. The assembly of claim 16, wherein a portion of the cam further comprises a mechanical stop that engages the elongated hollow portion limiting rotation of the cam to an arc.

18. A closeable rotating housing comprising:
a first housing having a first face substantially in a first plane;
a second housing coupled to the first housing and rotatable relative thereto about a rotation axis perpendicular to the first plane;
a cam coupled to the second housing and rotatable about the rotation axis in the first plane; and
a follower assembly carried in the first housing, enclosing a portion of the cam, extending radially from the rotary axis in the first plane, the follower assembly comprising a hollow portion, a follower enclosed in the hollow portion and coupled to the cam, and a yielding element enclosed in the hollow portion urging the follower against the cam,
wherein the follower reciprocates perpendicularly to the rotary axis, within the first plane and urging the cam to rotate.

19. The housing of claim 18, wherein a reciprocating axis of the of the follower is substantially perpendicular to and offset from the rotation axis.

20. A mechanism for rotating at least a first and a second housing element of a device with respect to one another, where the first and second housing elements have a common axis of rotation, which is substantially perpendicular to a front surface of the device, said mechanism comprising:
a biasing member having a first end coupled to a connection point of the first housing and a second end;
a cam coupled to the follower and a pivot member, the cam rotateable about the common axis of rotation; and
a retaining element fixed relative to the second housing element and coupled to the cam; and
a guide member engaged to one of the first and second housing elements and the cam, the guide member guiding the second end portion of the baising member to engage the a contoured surface of the cam, and wherein the guide member carries the biasing member.

21. The mechanism of claim 20, the biasing member comprises a compression member and a follower, the guide member guiding the follower to engage the contoured surface of the cam.

22. A wireless communication device comprising:
a first housing having a first face substantially in a first plane;
a second housing coupled to the first housing and rotatable relative thereto about a rotation axis perpendicular to the first plane;
a transceiver carried in one of the first housing or the second housing; and
a biasing assembly coupled between the first housing and the second housing such that a cam portion of the biasing assembly is rotatable about the rotation axis in the first plane, and a follower portion engaging the cam portion, the follower guided to engage the cam by a guide member and urging the follower against the cam,
wherein the follower reciprocates perpendicularly to the rotation axis, within the first plane and urging the cam to rotate.
